(19) United States
(12) Patent Application Publication
(10) Pub. No.: US 2015/0211845 A1
(43) Pub. Date: Jul. 30, 2015

(54) Methods and Systems for Applying Weights to Information From Correlated Measurements for Likelihood Formulations Based on Time or Position Density

(71) Applicant: Google Inc., Mountain View, CA (US)

(72) Inventors: Etienne Le Grand, Mountain View, CA (US); Brian Patrick Williams, Mountain View, CA (US)

(73) Assignee: Google Inc., Mountain View, CA (US)

(21) Appl. No.: 14/164,427

(22) Filed: Jan. 27, 2014

(51) Int. Cl. G01B 21/00

(52) U.S. Cl. CPC G01B 21/00

(57) ABSTRACT

Within examples, methods and systems for applying weights to information from correlated measurements for likelihood formulations based on time or position density are described. An example method includes receiving data from sensors of a device for an estimation of movement of the device, determining measurements from the data that are collected within a threshold time of each other or collected from locations within a threshold distance of each other, determining a magnitude of a weight to apply to the determined measurements based on a number of measurements in the determined measurements, and applying, by a processor, the weight to the determined measurements to reduce influence of the determined measurements on the estimation of movement of the device.

### BACKGROUND

Unless otherwise indicated herein, the materials described in this section are not prior art to the claims in this application and are not admitted to be prior art by inclusion in this section.

A location of a computing device can be determined using many different techniques including based either on Global Positioning System (GPS) data or on data associated with a wireless access point, such as a cellular base station or an 802.11 access point. For example, a mobile computing device may receive a GPS signal and responsively determine its position on the face of the Earth (e.g. an absolute location). In a different example, a mobile computing device may receive a signal from either a cellular base station or an 802.11 access point. The cellular base station or an 802.11 access point may estimate an exact location. Based on the location of either the cellular base station or an 802.11 access point, the mobile computing device can calculate its exact position.

Within some instances, a localization of a mobile computing device may occur via use of data from multiple different networks. Many location based services can be provided to a mobile computing device based on determining the location of the mobile computing device.

### SUMMARY

In one example, a method is provided that comprises receiving data from sensors of a device for an estimation of movement of the device, determining measurements from the data that are collected within a threshold time of each other or collected from locations within a threshold distance of each other, determining a magnitude of a weight to apply to the determined measurements based on a number of measurements in the determined measurements, and applying, by a processor, the weight to the determined measurements to reduce influence of the determined measurements on the estimation of movement of the device.

In another example, a non-transitory computer readable medium having stored therein instructions, that when executed by a computing device, cause the computing device to perform functions is provided. The functions comprise receiving data from sensors of a device for an estimation of movement of the device, determining measurements from the data that are collected within a threshold time of each other or collected from locations within a threshold distance of each other, determining a magnitude of a weight to apply to the determined measurements based on a number of measurements in the determined measurements, and applying the weight to the determined measurements to reduce influence of the determined measurements on the estimation of movement of the device.

In still another example, a system is provided that comprises one or more processors, and data storage configured to store instructions that, when executed by the one or more processors, cause the system to perform functions. The functions comprise receiving data from sensors of a device for an estimation of movement of the device, determining measurements from the data that are collected within a threshold time of each other or collected from locations within a threshold distance of each other, determining a magnitude of a weight to apply to the determined measurements based on a number of measurements in the determined measurements, and applying the weight to the determined measurements to reduce influence of the determined measurements on the estimation of movement of the device.

In yet another example, a system is provided that comprises a means for receiving data from sensors of a device for an estimation of movement of the device, a means for determining measurements from the data that are collected within a threshold time of each other or collected from locations within a threshold distance of each other, a means for determining a magnitude of a weight to apply to the determined measurements based on a number of measurements in the determined measurements, and a means for applying the weight to the determined measurements to reduce influence of the determined measurements on the estimation of movement of the device.

These as well as other aspects, advantages, and alternatives, will become apparent to those of ordinary skill in the art by reading the following detailed description, with reference where appropriate to the accompanying figures.

### BRIEF DESCRIPTION OF THE FIGURES

FIG. 1 illustrates an example communication system in which an example method may be implemented.

FIG. 2 illustrates a schematic drawing of an example device.

FIG. 3 illustrates a schematic drawing of another example computing device.

FIG. 4 is a flow diagram illustrating an example method for determining a location or movement of a device.

FIG. 5 is a block diagram of an example method modifying a history of geographic locations of a computing device, in accordance with at least some embodiments described herein.

FIG. 6 illustrates a conceptual example of a device traversing a pathway and collecting data along the pathway.

FIG. 7 illustrates a conceptual example of a device traversing another pathway and collecting data along the pathway.

### DETAILED DESCRIPTION

The following detailed description describes various features and functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

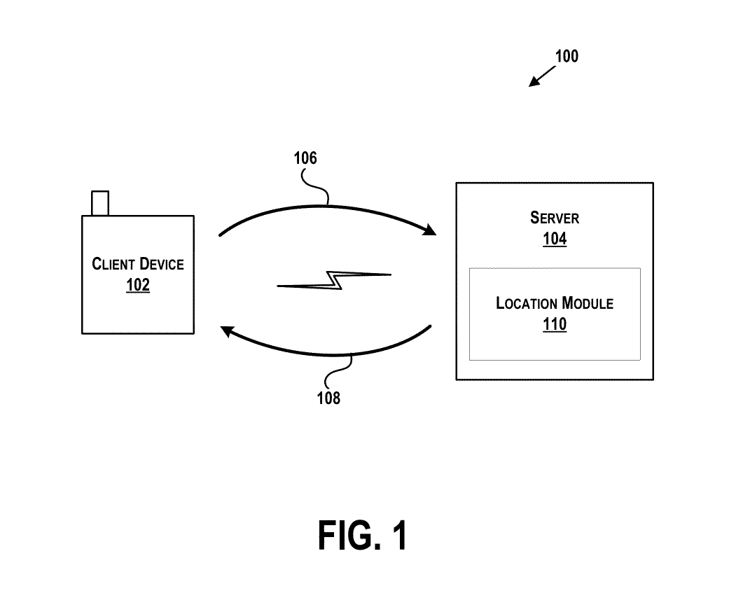

Referring now to the figures, FIG. 1 illustrates an example communication system 100 in which an example method may be implemented. In FIG. 1, a client device 102 may communicate with a server 104 via one or more wired and/or wireless interfaces. The client device 102 and the server 104 may communicate within a network. Alternatively, the client device 102 and the server 104 may each reside within a respective network.

The client device 102 may be any type of computing device or transmitter including a laptop computer, a mobile telephone, or tablet computing device, etc., that is configured to transmit data 106 to or receive data 108 from the server 104 in accordance with the method and functions described herein. The client device 102 may include a user interface, a communication interface, a processor, and data storage comprising instructions executable by the processor for carrying out one or more functions relating to the data sent to, or received by, the server 104. The user interface may include buttons, a touchscreen, a microphone, and/or any other elements for receiving inputs, as well as a speaker, one or more displays, and/or any other elements for communicating outputs.

The server 104 may be any entity or computing device arranged to carry out the method and computing device functions described herein. Further, the server 104 may be configured to send data 108 to or receive data 106 from the client device 102. The server 104 may include a location module 110 which may be configured to process the data 106 received from the client device 102 to determine a locations (present and historical) associated with the client device 102.

The data 106 received by the server 104 from the client device 102 may take various forms. For example, the client device 102 may provide information indicative of a location of the client device 102, movement of the client device 102, or inputs from a user of the client device 102. The server 104 may then process the data 106 to identify a location history that matches to the received data.

The data 108 sent to the client device 102 from the server 104 may take various forms. For example, the server 104 may send to the client device 102 an indication of location, updated location history information, or information based on the locations of the device.

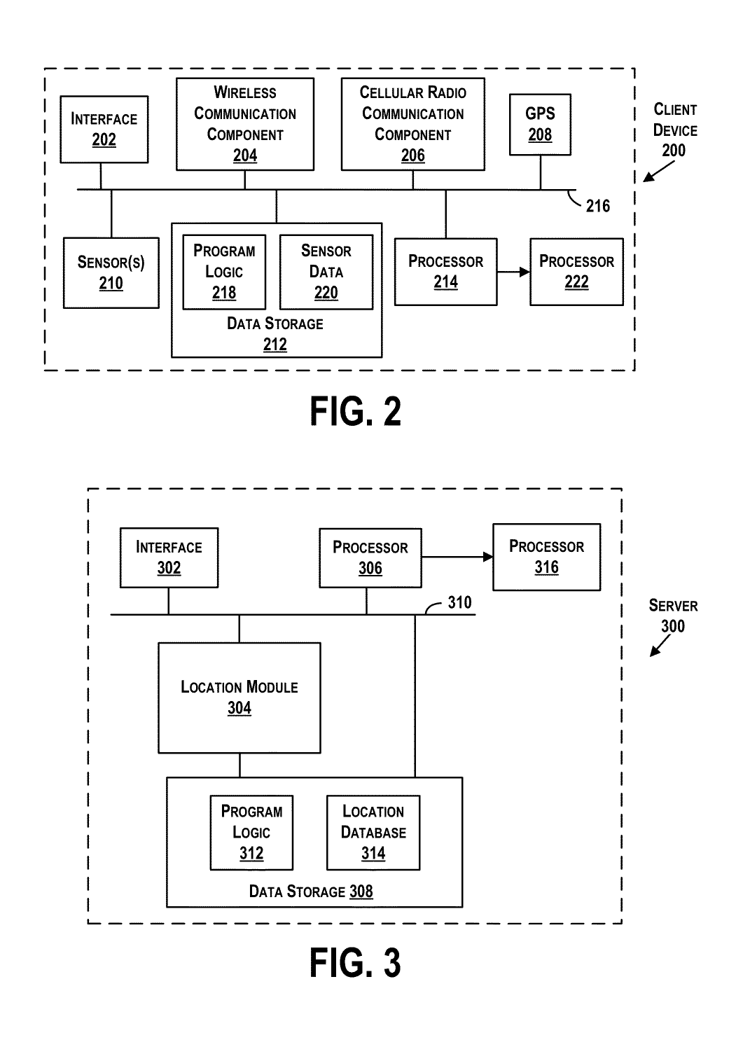

FIG. 2 illustrates a schematic drawing of an example device 200. In FIG. 2, the computing device takes a form of a client device 200. In some examples, some components illustrated in FIG. 2 may be distributed across multiple computing devices. However, for the sake of example, the components are shown and described as part of one example client device 200. The client device 200 may be or include a mobile device, desktop computer, email/messaging device, tablet computer, or similar device that may be configured to perform the functions described herein.

In some implementations, the client device 200 may include a device platform (not shown), which may be configured as a multi-layered Linux platform. The device platform may include different applications and an application framework, as well as various kernels, libraries, and runtime entities. In other examples, other formats or systems may operate the client device 200 as well.

The client device 200 may include an interface 202, a wireless communication component 204, a cellular radio communication component 206, a global position system (GPS) 208, sensor(s) 210, data storage 212, and a processor 214. Components illustrated in FIG. 2 may be linked together by a communication link 216. The client device 200 may also include hardware to enable communication within the client device 200 and between the client device 200 and another computing device (not shown), such as a server entity. The hardware may include transmitters, receivers, and antennas, for example.

The interface 202 may be configured to allow the client device 200 to communicate with another computing device (not shown), such as a server. Thus, the interface 202 may be configured to receive input data from one or more computing devices, and may also be configured to send output data to the one or more computing devices. In some examples, the interface 202 may also maintain and manage records of data received and sent by the client device 200. In other examples, records of data may be maintained and managed by other components of the client device 200. The interface 202 may also include a receiver and transmitter to receive and send data. In other examples, the interface 202 may also include a user-interface, such as a keyboard, microphone, touchscreen, etc., to receive inputs as well.

The wireless communication component 204 may be a communication interface that is configured to facilitate wireless data communication for the client device 200 according to one or more wireless communication standards. For example, the wireless communication component 204 may include a Wi-Fi communication component that is configured to facilitate wireless data communication according to one or more IEEE 802.11 standards. As another example, the wireless communication component 204 may include a Bluetooth communication component that is configured to facilitate wireless data communication according to one or more Bluetooth standards. Other examples are also possible.

The processor 214 may be configured to determine one or more geographical location estimates of the client device 200 using one or more location-determination components, such as the wireless communication component 204, the cellular radio communication component 206, or the GPS 208. For instance, the processor 214 may use a location-determination algorithm to determine a location of the client device 200 based on a presence and/or location of one or more known wireless access points within a wireless range of the client device 200. In one example, the wireless location component 204 may determine the identity of one or more wireless access points (e.g., a MAC address) and measure an intensity of signals received (e.g., received signal strength indication) from each of the one or more wireless access points. The received signal strength indication (RSSI) from each unique wireless access point may be used to determine a distance from each wireless access point. The distances may then be compared to a database that stores information regarding where each unique wireless access point is located. Based on the distance from each wireless access point, and the known location of each of the wireless access point, a location estimate of the client device 200 may be determined.

In another instance, the processor 214 may use a location-determination algorithm to determine a location of the client device 200 based on nearby cellular base stations. For example, the cellular radio communication component 206 may be configured to at least identify a cell from which the client device 200 is receiving, or last received, signal from a cellular network. The cellular radio communication component 206 may also be configured to measure a round trip time (RTT) to a base station providing the signal, and combine this information with the identified cell to determine a location estimate. In another example, the cellular communication component 206 may be configured to use observed time difference of arrival (OTDOA) from three or more base stations to estimate the location of the client device 200.

In still another instance, the processor 214 may use a location-determination algorithm to determine a location of the client device 200 based on signals sent by GPS satellites above the Earth. For example, the GPS 208 may be configured to estimate a location of the mobile device by precisely timing signals sent by the GPS satellites.

In some examples, the processor 214 may use a location-determination algorithm that combines location estimates determined by multiple location-determination components, such as a combination of the wireless communication component 204, the cellular radio component 206, and the GPS 208.

The sensor 210 may include one or more sensors, or may represent one or more sensors included within the client device 200. Example sensors include an accelerometer, gyroscope, pedometer, light sensors, microphone, camera, or other location and/or context-aware sensors.

The data storage 212 may store program logic 218 that can be accessed and executed by the processor 214. The data storage 210 may also store collected sensor data 220 that may include data collected by any of the wireless communication component 204, the cellular radio communication component 206, the GPS 208, and any of sensors 210.

The communication link 216 is illustrated as a wired connection; however, wireless connections may also be used. For example, the communication link 216 may be a wired serial bus such as a universal serial bus or a parallel bus, or a wireless connection using, e.g., short-range wireless radio technology, communication protocols described in IEEE 802.11 (including any IEEE 802.11 revisions), or Cellular technology, among other possibilities.

The client device 200 is illustrated to include an additional processor 222. The processor 222 may be configured to control other aspects of the client device 200 including displays or outputs of the client device 200 (e.g., the processor 222 may be a GPU). Example methods described herein may be performed individually by components of the client device 200, or in combination by one or all of the components of the client device 200. In one instance, portions of the client device 200 may process data and provide an output internally in the client device 200 to the processor 222, for example. In other instances, portions of the client device 200 may process data and provide outputs externally to other computing devices.

FIG. 3 illustrates a schematic drawing of another example computing device. In FIG. 3, the computing device takes a form of a server 300. In some examples, some components illustrated in FIG. 3 may be distributed across multiple servers. However, for the sake of example, the components are shown and described as part of one example server 300. The server 300 may be a computing device, cloud, or similar entity that may be configured to perform the functions described herein.

The server 300 may include a communication interface 302, a location module 304, a processor 306, and data storage 308. All of the components illustrated in FIG. 3 may be linked together by a communication link 310 (e.g., wired or wireless link). The server 300 may also include hardware to enable communication within the server 300 and between the server 300 and another computing device (not shown). The hardware may include transmitters, receivers, and antennas, for example.

The communication interface 302 may allow the server 300 to communicate with another device (not shown), such as a mobile phone, personal computer, etc. Thus, the communication interface 302 may be configured to receive input data from one or more computing devices, and may also be configured to send output data to the one or more computing devices. In some examples, the communication interface 302 may also maintain and manage records of data received and sent by the server 300. In other examples, records of data may be maintained and managed by other components of the server 300.

The location module 304 may be configured to receive data from a client device and determine a geographic location of the client device. The determination may be based on outputs of an accelerometer, gyroscope, or other sensors of the client device, as well as based on location determinations of the client device. The location module 304 may further be configured to determine and store a history of sensor measurements of the client device for later reprocessing based on updated data pertaining to networks or information used to the determine the locations.

The data storage 308 may store program logic 312 that can be accessed and executed by the processor 306. The data storage 310 may also include a location database 314 that can be accessed by the processor 306 as well, for example, to retrieve information regarding wireless access points, locations of satellites in a GPS network, floor plans of a building, etc., or any other type of information useful for determining a location of a client device.

The server is illustrated with a second processor 316 which may be an application specific processor for input/output functionality. In other examples, functions of the processor 306 and the processor 316 may be combined into one component.

Within examples, measurements collected from various sensors of a device (such as WiFi components, GPS sensors, and inertial sensors) can be combined with information from external databases (such as known locations of WiFi access points or building floor plans) to estimate a location or movement of the device in real-time. Recording the real-time location estimate at all times (or intervals/increments of time) may also produce a location history.

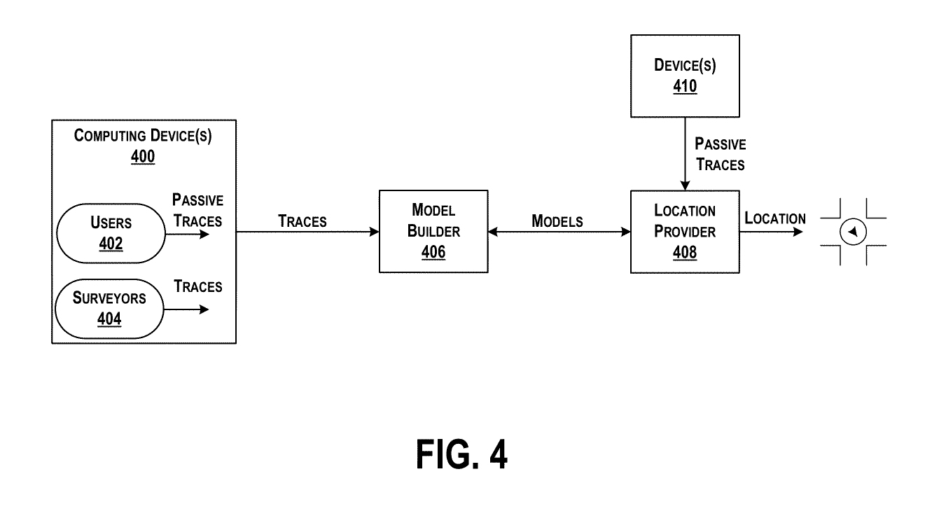

FIG. 4 is a flow diagram illustrating an example method for determining a location or movement of a device. Initially, computing device(s) 400, operated by users 402 or surveyors 404, may traverse areas in an environment and output traces to a model builder 406. A device operated by a user 402 may output traces passively (i.e., the device may be configured to output the trace data with no additional user input), including raw data output by sensors of the device like WiFi scans, GPS data, accelerometer data, etc. Each trace may be associated with a time the data was collected, and thus, for traces that include GPS data, other data in the traces also has location-specific references. A device operated by a surveyor 404 may have location-specific references for all traces, whether due to associated GPS data or manual input of location information.

The model builder 406 may be a module on a computing device or server, and may be configured to generate a model of the environment based on the received traces. The model builder 406 may include a trace localizer and a map builder. The model builder 406 may access reference data such as information like strength of signal (RSSI) for WiFi access points in the environment at specific locations in the environment, or other landmark data of the environment. The model builder 406 may be configured to generate a map or path of the device based on the traces. In one example, the model builder 406 may utilize GPS data to determine locations of the device over time, utilize dead reckoning (based on accelerometer and gyroscope outputs) to project a path, and optimize the path by jointly combining each. The model builder 406 may further optimize the path to match WiFi scan data to the reference WiFi maps to align a path that most likely resembles a path that the device traversed through the environment.

A location provider 408 may access a model output by the model builder 406 to determine locations of other device(s) 410 based on provided passive traces as well. Within examples, the location provider 408 may return a location of the device or an estimation of movement of the device to the device 410 based on data received in the traces.

Traces received from devices may include a variety of measurements from multiple different sensors, and may include a variety of measurements collected over time or at various locations. A trace may refer to a sensor log or a collection of data output from sensors on the device over some time period. The sensors that output data may be selected, or data to be included within the sensor log may also be selected. In some examples, a trace of data may include all data collected by a device (using a number of sensors) over a given time frame (e.g., about 5 seconds, or perhaps about 5 minutes long). Measurements in a trace or from trace to trace may be considered statistically independent. However, in instances in which the measurements are collected from positions/locations in close proximity or collected close in time, the measurements may have correlations. To reflect the fact that time or position can influence measurement noises, information from measurements that are close in time or in space can be discounted so as to down-weight information received from each measurement, such that when a same or similar data measurement is observed more than once that satisfies the time or position correlation, the measurements can be assigned weights to discount the information. By discounting correlated measurements, errors in such measurements may not be considered more heavily within estimations of location or movement of the device. Also, however, by discounting correlated measurements, all information including erroneous noise signals as well as correct data measurements, are discounted, and thus some information may be lost.

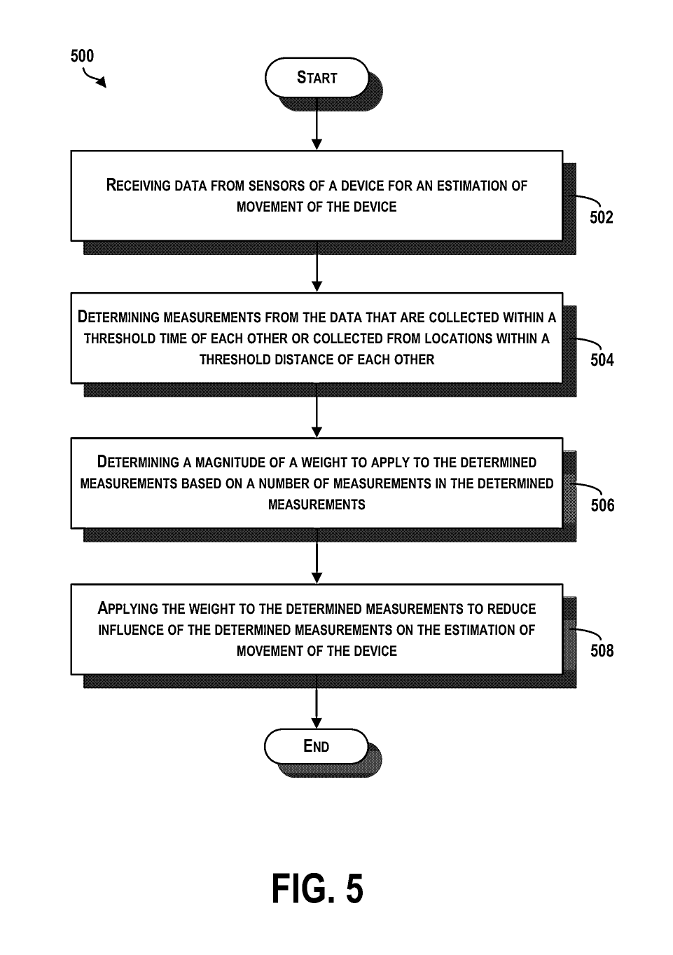

FIG. 5 is a block diagram of an example method modifying a history of geographic locations of a computing device, in accordance with at least some embodiments described herein. Method 500 shown in FIG. 5 presents an embodiment of a method that, for example, could be used with the system 100 in FIG. 1, the device 200 in FIG. 2, the server 300 in FIG. 3, or the system in FIG. 4, for example, or may be performed by a combination of any components of in FIGS. 1-4. Method 500 may include one or more operations, functions, or actions as illustrated by one or more of blocks 502-508. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for the method 500 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 500 and other processes and methods disclosed herein, each block in FIG. 5 may represent circuitry that is wired to perform the specific logical functions in the process.

Functions of the method 500 may be fully performed by a computing device, or may be distributed across multiple computing devices and/or a server. In some examples, the computing device may receive information from sensors of the computing device, or where the computing device is a server the information can be received from another device that collects the information. The computing device could further communicate with a server to determine the matching media files, for example.

At block 502, the method 500 includes receiving data from sensors of a device for an estimation of movement of the device. The sensors may include an accelerometer, a gyroscope, a WiFi transceiver, a GPS module, a magnetometer, a barometer, and a Bluetooth transceiver, for example, and the data may include a combination of measurements output from any of these sensors. The data may be provided within a trace output by the device, and the trace may be used to determine the estimation of movement of the device. The data may be usable to estimate the movement of the device.

At block 504, the method 500 includes determining measurements from the data that are collected within a threshold time of each other or collected from locations within a threshold distance of each other. Within examples, the threshold time may be within about 20 seconds, about 10 seconds, about 5 seconds, or a range of time from about 5-30 seconds. The data may include timestamps that indicate when the data was collected, or that indicate when the data was output by the sensor. The timestamp may be used to determine whether the data is within the threshold time. Alternatively, a device that receives the data may timestamp a receipt time of the data, and use the receipt time as a data collection time for purposes of determining data collected within the threshold time of each other.

In addition, in examples, the threshold distance may be within about five meters, about 10 meters, or within a range of about 2-10 meters. For data that includes information indicative of a geographic position or location, such information may be used to determine whether the data was collected within the threshold distance of each other. As an example, in a group of data received, a GPS position as well as a WiFi scan may be received. The GPS position may correspond to where the WiFi scan was collected, and thus, can be used to determine if the WiFi scan is within a threshold distance of other WiFi scans that also have corresponding position coordinates.

Other information may be used as well as geographic location coordinates to determine whether data is collected from locations within the threshold distance of each other. For example, in an instance in which measurements have images associated with the measurements, the images may include information of the location. Images that are similar or have small variances can be indicative of similar locations, and thus, when images have less than a threshold difference between them, the images may be indicative of close proximity geographic locations. In another example, in an instance in which measurements include associated WiFi scans, the scans may indicate wireless access points (AP), which may have known locations. Thus, the APs may be used as location landmarks as well. Any number of other measurements can have associated location landmarks, other than or in addition to specific geographic coordinates, that may be used to determine whether the data is collected from locations within the threshold distance of each other.

As a further example, similarity in measurements can also be used as a proxy to distance. For example, measuring a same magnetic field signature variation or detecting a same ambient sound can be used as a signal that two devices are in the same (or substantially similar) position, or one device returned to the same position. Signals substantially similar, which may include signals having a magnitude exactly the same and/or being one or more deviations from exactly the same, for example.

At block 506, the method 500 includes determining a magnitude of a weight to apply to the determined measurements based on a number of measurements in the determined measurements, and at block 508, the method 500 includes applying the weight to the determined measurements to reduce influence of the determined measurements on the estimation of movement of the device.

In some examples, the weight may be a fraction less than one so as to down-weight the determined measurements. As one example, the data from sensors of the device may include consecutive GPS measurements that are about the same (e.g., vary by insubstantial coordinate differences), and the weight to be applied to down-weight the consecutive GPS measurements can be based on a number of the consecutive GPS measurements. It may be desired to consider all consecutive GPS measurements as a single measurement, and thus, based on ten consecutive GPS measurements, the magnitude of the weight to apply to each can be one tenth.

In another example, when measurements from the data are determined to be substantially the same, and the weight to be applied can be calculated so as to consider the measurements as a single measurement for purposes of the estimation of movement of the device (e.g., weight=[1/(number of measurements)]).

In other examples, the weight to be applied can be based on an amount of correlation of or between the measurements so as to increase the weight based on a higher correlation. Correlation between the measurements can be related to the time between collection of the determined measurements or the distance between locations of collection of the determined measurements, such that for lower times or shorter distances, a higher correlation may be present. In still other examples, correlation may be based on measurements that are consecutively output from the sensors of the device within the threshold time of each other.

In still further examples, the weight may be applied to measurements from the data that are collected within the threshold time of each other and collected from locations within the threshold distance of each other. In such an instance, a higher correlation may be present.

The estimation of movement of the device can be determined based on the weighted determined measurements. In some examples, the measurements and weights can be provided to a location provider or server that determines the estimations, and provides the estimations in return.

In other examples, a Viterbi algorithm may be used to process sensor data to determine estimations of movement of the device by determining a most likely set of possible locations over time for the device based on the collected sensor measurements, and discounting such measurements based on the applied weights. In some examples, the Viterbi algorithm may be used to divide a physical space into a graph of locations with edges indicating possible movement between locations. For example, a building may be defined as having nodes for each room and corridor in the building, and edges indicate possible pathways to move through the building based on locations of doors. The Viterbi algorithm computes a most likely path through the graph based on collected sensor measurements. In a specific example, a building may include two businesses, and as the computing device moves through the building, sensor measurements from WiFi may appear similar in location and can be difficult to distinguish as to an exact location to determine which business the computing device is in. At a later time, movement up stairs can be detected by an accelerometer signal in the computing device. Based on reference to a floor plan, it may be determined that only one of the businesses has stairs, and from this new information, the Viterbi algorithm adjusts a likelihood of the two formerly ambiguous locations to identify one where the computing device entered a business with the stairs as more likely. A set of most likely possible location histories can be maintained and updated each time new information is provided.

In some examples, a non-linear least-squares solver can be used to perform smoothing and mapping to estimate movement of the device. An initial hypothesis of locations of the computing device can be determined (e.g., which may include locations along a projected trajectory of the computing device), such as based on GPS data. The initial hypothesis can be iteratively adjusted based on models of motion and sensor characteristics using gradient descent. A location at all points in history can be determined (covering a specified time) that have a lowest error compared to a model for each sensor and an external database of information. In some examples, the non-linear least-squares solver may be used to estimate location positions in continuous space. All sensor measurements may be input and a location at all points in history can be determined that have a lowest error compared to a model for each sensor and an external database of information, such as WiFi access point positions. A full trajectory can be estimated jointly and uncertainties and noise inherent in sensor measurements may be taken into account, although discounted by the applied weights. Initially, a guess of a trajectory is used (e.g., such as from GPS or best guess of position for each individual WiFi scan), and the initial guess is iteratively adjusted by moving each location guess in the history in a direction that better fits all of the models of motion and sensor characteristics using gradient descent. Eventually, positions are moved to a local minima where a location history may not be adjusted any more without making an estimate worse. A final result is an estimate for the location history taking into account measurements from the entire history.

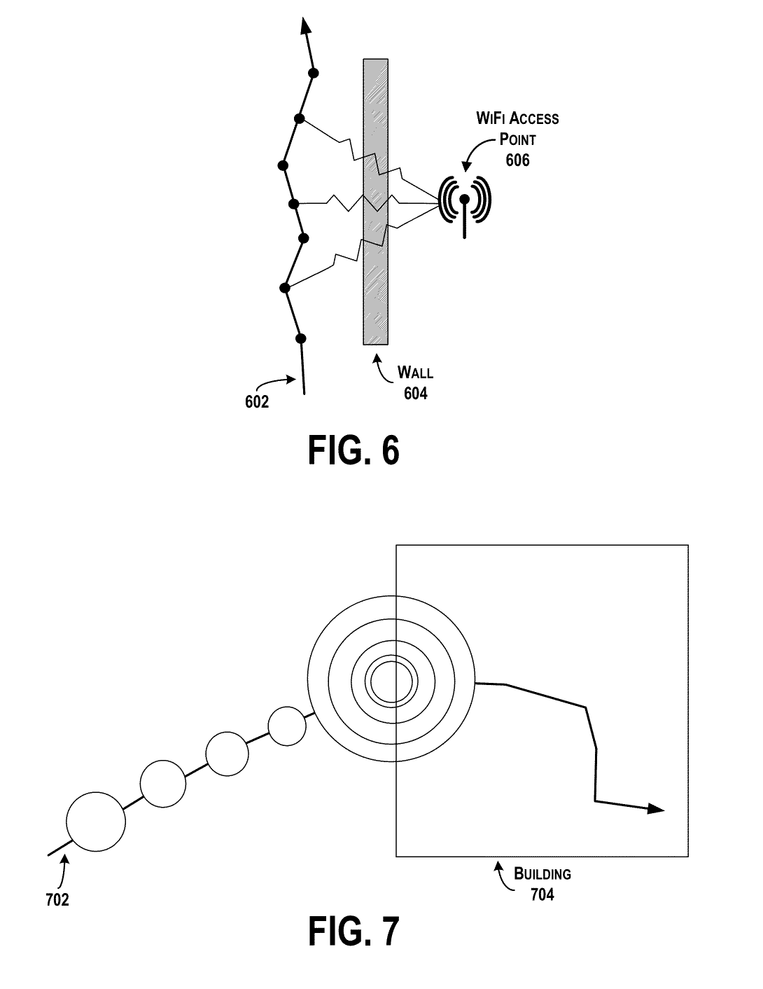

FIG. 6 illustrates a conceptual example of a device traversing a pathway and collecting data along the pathway. A device path 602 is shown, and each dot along the path 602 may indicate a data collection location where data is collected by one or more sensors of the device. In the example shown in FIG. 6, WiFi scans are performed at each data collection location. A wall 604, or other obstruction, may be between the device and a WiFi access point 606. The wall 604 may block the WiFi signals to the device. When measuring strength of a WiFi signal, the strength can be used as a proxy to determine a distance of the WiFi access point 606 to the device. If the device is close to the WiFi access point 606, the signal should be strong, and if the device is far from the WiFi access point 606, the signal should be weak. If the signal becomes stronger over time, the device is generally assumed to be traveling closer to the WiFi access point 606. However, the wall 604 may block a signal even when the device is next to the WiFi access point 606.

WiFi strength (RSSI) can be measured and determined by the device, and any correlated errors may cause traces output by the device to influence estimations of movement or location of the device to be further from the WiFi access point 606 than the device really is when the wall 604 blocks a signal. Each signal of this given trace may thus be weak for the same reason, and thus, the signals are correlated. When a correlation is found, such as based on data collected in close proximity or within a time threshold, the effect of the data can be down-weighted. Thus, multiple consecutive WiFi measurements are likely to suffer from the same biases or interference (e.g., the wall 604), and cause repetitive errors that can be down-weighted accordingly. In one example, two measurements from a WiFi scan may be considered correlated if the measurements are collected from locations less than about 5 meters. Measurements are more correlated with others that are closer in time/space than to others that are further away (e.g., correlated thresholds may include about 10 meters for space or about 10-20 seconds for time).

In the example shown in FIG. 6, seven WiFi measurements may be collected along the path 602 and provided in a trace. Each may be collected within the preset or determined threshold of time (e.g., 5-10 seconds), and thus, each may be down-weighted by a magnitude, such as 1/7.

In other examples, the magnitude can be computed as any fraction less than one. As another specific example, for each measurement x, a correlation can be determined by:

correlation_sum_proxy=Σ_{y in neighboring measurements}(correlation proxy (x,y))

The correlation proxy can be a function of a distance between x and y. As a specific example, a correlation proxy function may be:

triangle_correlation_proxy(x, y)=a*max(0, 1−distance(x,y)/b)

where a and b are constants. When using the information of the measurement in a negative-log-likelihood function, the measurement can be discount by the correlation_sum_proxy.

In some examples, false measurements being reported by any sensors (e.g., the GPS sensor) can be ignored (i.e., by setting the weight to zero) if there is knowledge of which measurements are true or false. However, in the absence of knowledge of which reported measurements are true, down-weighting measurements may provide better estimates than including all measurements naively.

FIG. 7 illustrates a conceptual example of a device traversing another pathway and collecting data along the pathway. In the example in FIG. 7, the device is collected GPS measurements along a path 702, and each GPS data collection location is shown by a circle (i.e., indicating a possible physical location of the device in the circle. The device may enter a building 704, and sometimes, a GPS sensor may continue providing outputs for some time after entering the building even though the GPS sensor may have lost a signal with a GPS positioning satellite. In this example, the GPS sensor is shown to continue to provide outputs indicating that the device is located at an entrance of the building 704 (e.g., perhaps for 10 consecutive readings), even though the device has traversed into the building further. Each of the consecutive outputs may be treated together as one reading so as to down-weight each measurement by a weight. Thus, consecutive similar or same measurements can be discounted. Similar or same measurements include those nearby in time or space so as to be correlated and discounted.

In the example shown in FIG. 7, if ten correlated measurements are received, each can be down-weighted to 1/10 so that a total effect is one measurement indicating a location at a lost signal location instead of ten such measurements indicating the location at the lost signal location, which would adversely cause an estimate of the movement of the device to change more heavily.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A method comprising:
receiving data from sensors of a device, wherein the data are usable to estimate movement of the device;
determining measurements from the data that are collected within a threshold time of each other or collected from locations within a threshold distance of each other;
determining a magnitude of a weight to apply to the determined measurements based on a number of measurements in the determined measurements; and
applying, by one or more processors, the weight to the determined measurements to reduce influence of the determined measurements on an estimation of movement of the device.

2. The method of claim 1, wherein applying the weight to the determined measurements comprises down-weighting the determined measurements.

3. The method of claim 1, wherein the data from sensors of the device comprises GPS data, and wherein consecutive GPS measurements are about the same, and wherein applying the weight comprises applying the weight to the consecutive GPS measurements to down-weight the consecutive GPS measurements based on a number of the consecutive GPS measurements.

4. The method of claim 1, wherein receiving data from sensors of a device comprises receiving data from one or more sensors including an accelerometer, a gyroscope, a WiFi transceiver, and a GPS module.

5. The method of claim 1, wherein the threshold time is within about 20 seconds.

6. The method of claim 1, wherein the threshold distance is within about five meters.

7. The method of claim 1, further comprising applying the weight to measurements from the data that are collected within the threshold time of each other and collected from locations within the threshold distance of each other.

8. The method of claim 1, further comprising:
determining given measurements from the data that are substantially the same; and
applying a given weight to the determined given measurements so as to consider the determined given measurements as a single measurement for purposes of the estimation of movement of the device.

9. The method of claim 1, further comprising determining the estimation of movement of the device based on the weighted determined measurements.

10. The method of claim 1, further comprising:
determining an amount of correlation of the determined measurements, wherein the amount of correlation is related to the time between collection of the determined measurements or the distance between locations of collection of the determined measurements; and
applying the weight to the determined measurements based on the amount of correlation of the determined measurements so as to increase the weight based on a higher correlation.

11. The method of claim 1, further comprising:
determining given measurements from the data that are consecutively output from the sensors of the device within the threshold time of each other; and
determining a given magnitude of the weight to apply to the given consecutive measurements based on a number of measurements in the given consecutive measurements; and
applying the weight to the given consecutive measurements to reduce influence of the given measurements on the estimation of movement of the device.

12. A non-transitory computer readable medium having stored therein instructions, that when executed by a computing device, cause the computing device to perform functions comprising:
receiving data from sensors of a device, wherein the data are usable to estimate movement of the device;
determining measurements from the data that are collected within a threshold time of each other or collected from locations within a threshold distance of each other;
determining a magnitude of a weight to apply to the determined measurements based on a number of measurements in the determined measurements; and
applying the weight to the determined measurements to reduce influence of the determined measurements on an estimation of movement of the device.

13. The non-transitory computer readable medium of claim 12, wherein applying the weight to the determined measurements comprises down-weighting the determined measurements.

14. The non-transitory computer readable medium of claim 12, wherein the functions further comprise:
determining given measurements from the data that are substantially the same; and
applying a given weight to the determined given measurements so as to consider the determined given measurements as a single measurement for purposes of the estimation of movement of the device.

15. The non-transitory computer readable medium of claim 12, wherein the functions further comprise:
determining an amount of correlation of the determined measurements, wherein the amount of correlation is related to the time between collection of the determined measurements or the distance between locations of collection of the determined measurements; and
applying the weight to the determined measurements based on the amount of correlation of the determined measurements so as to increase the weight based on a higher correlation.

16. The non-transitory computer readable medium of claim 12, wherein the functions further comprise:
determining given measurements from the data that are consecutively output from the sensors of the device within the threshold time of each other; and
determining a given magnitude of the weight to apply to the given consecutive measurements based on a number of measurements in the given consecutive measurements; and
applying the weight to the given consecutive measurements to reduce influence of the given measurements on the estimation of movement of the device.

17. A system comprising:
one or more processors;
data storage configured to store instructions that, when executed by the one or more processors, cause the system to perform functions comprising:
receiving data from sensors of a device, wherein the data are usable to estimate movement of the device;
determining measurements from the data that are collected within a threshold time of each other or collected from locations within a threshold distance of each other;
determining a magnitude of a weight to apply to the determined measurements based on a number of measurements in the determined measurements; and
applying the weight to the determined measurements to reduce influence of the determined measurements on an estimation of movement of the device.

18. The system of claim 17, wherein the data from sensors of the device comprises GPS data, and wherein consecutive GPS measurements are about the same, and wherein applying the weight comprises applying the weight to the consecutive GPS measurements to down-weight the consecutive GPS measurements based on a number of the consecutive GPS measurement.

19. The system of claim 17, wherein receiving data from sensors of a device comprises receiving data from one or more sensors including an accelerometer, a gyroscope, a WiFi transceiver, and a GPS module.

20. The system of claim 17, wherein the functions further comprise:
determining given measurements from the data that are substantially the same; and
applying a given weight to the determined given measurements so as to consider the determined given measurements as a single measurement for purposes of the estimation of movement of the device.
